(19) United States
(12) Patent Application Publication
(10) Pub. No.: US 2007/0171058 A1
(43) Pub. Date: Jul. 26, 2007

(54) DIGITAL FLOORING DETECTION SYSTEM

(75) Inventors: Gareth J. Knowles, Williamsport, PA (US); Eli Hughes, State College, PA (US)

Correspondence Address: CAHN & SAMUELS LLP, 2000 P STREET NW, SUITE 200, WASHINGTON, DC, 20036, US

(73) Assignee: Latitude Broadband, Inc.

(21) Appl. No.: 11/462,041

(22) Filed: Aug. 2, 2006

Related U.S. Application Data
(60) Provisional application No. 60/704,448, filed on Aug. 2, 2005.

(51) Int. Cl. G08B 13/00; G08B 21/00

(52) U.S. Cl. 340/565; 340/666; 340/687

(57) ABSTRACT

A flooring system comprising a plurality of electrode pairs in contact with a metaplastic composite material. The metaplastic material is such that it locally conducts electrical current in an area where any load is applied to the metaplastic. An electric potential is applied to one or more interdigitated electrodes located at a face of the metaplastic material in line with applied loads. Larger area coverage can be obtained either by pre-installing a subsurface layer comprising of an array of interdigitated electrodes and their trace line outputs and then covering this layer with a tiling of metaplastic material sheets that is in direct contact with the array of interdigitated electrodes, or, by directly attaching one or more interdigitated electrodes and their output trace lines to an individual sections of metaplastic material and electrically interconnecting their outputs. By applying a sufficient number of interdigitated electrodes and sheets of the metaplastic material and monitoring the electrical current flowing in each interdigitated electrode so placed, it can be determined whether and where loads are being applied to the PCC flooring material and the approximate size and shape of the load.

### CROSS REFERENCE TO RELATED APPLICATIONS

This application is an application filed under 35 U.S.C. § 111(a) claiming benefit pursuant to 35 U.S.C. § 119(e)(1) of Provisional Application Ser. No. 60/704,448, filed on Aug. 2, 2005, which was filed pursuant to 35 U.S.C. § 111(b), the entire contents of which is incorporated herein by reference for all that it teaches.

### FIELD OF THE INVENTION

This invention relates generally to digital pressure sensor technology. More particularly, the invention relates to a flooring system with integrated digital pressure sensors rendering it possible to detect and record events where pressure is asserted on the flooring material.

### BACKGROUND OF THE INVENTION

It has long been desired to monitor various places for the entry of intruders and/or objects. For example, most buildings or installations that house or contain valuable or sensitive material today provide at least minimum security against intruders. Typically, this type of security is most commonly performed by using devices such as video cameras, thermal, e.g., infrared (IR), sensors, magnetic switches and laser perimeter fences. For example, U.S. Pat. No. 4,849,635 (“the '635 patent”), to Sugimoto, discloses an intruder detection system, as illustrated in FIG. 8, with an infrared detecting apparatus 1 that detects an intruder P by perceiving infrared rays that are incident on the intruder. The infrared rays contact the intruder within a plurality of ray enveloping spaces S1 to S5 that span between an infrared converging lens system 11 of the infrared detecting apparatus 1 and sub-domains D1 to D5 located within a specific area of the ground G. The ray enveloping spaces S1 to S5 are generated in a relatively dense pattern so an intruder P that intrudes into the specific area of the ground G crosses a plurality of the ray-enveloping spaces at any given instant.

According to the '635 patent, because a human is relatively tall, with a height hp as shown in FIG. 8, the number of ray-enveloping spaces which a human intruder P crosses at a given instant in time is selectively chosen to be two. Other numbers of ray-enveloping spaces for which a typical human intruder could cross at any given instant could be selectively chosen to be greater than two as well, depending on the width of the rays. In addition, the sub-domains D1 to D5 on ground G are spaced so that small animals or other objects that are substantially shorter than hp do not cross more than a single sub-domain Dn at any given time.

Thus, according to the '635 patent, the minimum intensity of detectable infrared radiation from a human intruder P is much stronger that the maximum intensity of detectable infrared radiation from an animal A. According to the '635 patent, distinguishing between a human intruder and an animal intruder is made easier. According to the '635 patent, a human intruder of typical height is detected and distinguished from a non-human intruder, such as a small animal, by detecting different levels of infrared energy.

Other systems that enable the detection of an intruder to be determined have been proposed as well. For example, U.S. Pat. No. 4,874,549 (“the '549 patent”), to Michalchik, discloses an apparatus utilizing pressure-sensitive material to form an electronic switch. In particular, in the '549 patent, a switch is at least partially controlled by the pressure sensitive electro-conductive switch shown in FIG. 8. The device illustrated in FIG. 8 comprises a pressure sensitive electro-conductive switch 24, which includes two opposing electrodes, 20a and 20b, on either side of a pressure-sensitive conductive material 10.

The material 10 in the '549 patent is an electro-conductive material made of a deformable elastomeric material impregnated with a plurality of electro-conductive micro-agglomerates of unbound finely divided electro-conductive carbon particles enclosed by a matrix of the elastomeric material and finely divided electro-conductive carbon particles bound together by the elastomeric material. The switch 24 is mounted on a platform 40, such as a floor. A lead 42 electrically connects one electrode 20a with one pole of a battery or voltage source 44. A lead 46 electrically connects the other pole of the battery to an electrical powered output device 48. A lead 50 electrically connects the output device 48 to the other electrode 20b of the switch.

According to the '549 patent, the switch system 38 can be used as an intruder detection device wherein the switch is secured to a floor at a particular location where it is desired to know if an intruder is approaching/leaving the area. The switch can be hidden beneath a carpet or rug and when a person or animal steps on the carpet or rug in the area of the switch, the circuit is closed and the battery energizes the electrical powered output device, which can be an alarm, or some other controllable device. The '549 patent further discloses that the system can be used as a counter to determine the number of people, vehicles, etc., that step on or otherwise put pressure on the switch.

However, while the monitoring systems described above can generally detect an intruder and potentially provide some general information about an intruder's location, they all have the undesirable property that the precise location of the intruder, as well as specific information regarding the amount of pressure being applied in the particular location, such as the intruder's weight, can not be determined at a specific instant in time. Moreover, previously proposed systems tend to be expensive to purchase and install, and are easily damaged.

### SUMMARY OF THE INVENTION

Illustrative, non-limiting embodiments of the present invention may overcome the aforementioned and other disadvantages associated with related art pressure-sensing detection and location systems. Also, the present invention is not necessarily required to overcome the disadvantages described above and an illustrative non-limiting embodiment of the present invention may not overcome any of the problems described above.

A system in accordance with the present invention addresses at least one of the above-mentioned problems with related art detection systems. For example, a non-limiting exemplary embodiment of the present invention provides a revolutionary advancement in intrusion or incursion monitoring that is both affordable and durable both to wear and tear and large physical overload conditions. According to one aspect of the invention a large number of individual pressure sensors, for example formed in a grid pattern, are embedded or otherwise integrated, e.g., as tiling, as sheet material similar to linoleum or as an underlay or pad beneath secondary flooring material such as carpet. The individual sensors are monitored in real-time to detect the presence of a pressure-causing object, such as an intruder or any other object capable applying at least a modicum of pressure, to precisely locate the person or object traversing and/or remaining stationary on the floor. Results of the real-time monitoring function can be recorded, for example, to enable the path of an intruder or object to be tracked over a specified duration of time.

According to another aspect of the invention the pressure-sensors used are capable of precisely sensing finite changes in pressure over a substantially large range of pressure values. More particularly, according to this aspect of the invention, a pressure-sensing device used in accordance with the invention operates in a substantially linear portion of a pressure versus resistance curve. Accordingly, when this type of pressure-sensing device is used together with, for example, the flooring system described above, very small changes in the amount of pressure being applied in any given location on the floor is detected. Therefore, according to this aspect of the invention, the precise location of an intruder can be detected as well as the precise weight of the intruder, e.g., as determined by the amount of pressure applied.

In accordance with one embodiment of the invention, the materials used to construct the sensors are relatively inexpensive, costing about twice as much as conventional floor tiling. By minimizing the size of the individual sensors within the flooring material, and selectively placing and spacing the sensors relative to each other, the spatial resolution of detectability with respect to the flooring material can be very high. That is, small tight interdigitated (IDT) electrode patterns can be placed on one surface of the tile within millimeters of each other, thus providing a very fine resolution with respect to location detection. Alternatively, larger and/or more widely spaced IDT patterning can be used, thus reducing sensor resolution for the same area, and resulting in a less finite resolution of location detection. Further, by arranging the sensors in a grid pattern, a digital “footprint” can be detected resembling the precise footprint of an intruder or any other object applying pressure to the sensors. In accordance with a further embodiment, as a pressure-causing event occurs, at least one floorprint (e.g., footprint) is digitally recorded and can be forwarded to a computer terminal, for example, such that security personnel or automated algorithms can monitor movement of the pressure-causing object.

An embodiment in accordance with the invention includes a flooring system comprising a sheet of pressure conduction composite operable to conduct electrical current when pressure is applied to at least one surface thereof and at least one pair of electrodes in electrical contact with the sheet of pressure conduction composite, wherein an electrical voltage is applied to one electrode of each pair of electrodes and electrical current flows from the one electrode through the sheet of pressure conduction composite and into the other electrode of the pair of electrodes when pressure is applied to said sheet of pressure conduction composite in the vicinity of the pair of electrodes.

A further exemplary embodiment of the invention includes a flooring system operable to detect pressure applied at any point on a flooring surface, the system comprising at least one sheet of pressure conduction composite covering at least a portion of the flooring surface and operable to conduct electrical current when pressure is applied thereto, at least one pressure pixel each comprising a pair of electrodes and a switch connected to one of the electrodes, a switch controlling portion connected to the switches and operable to controllably open and close the switches and a pixel reading portion connected to the switches and operable to measure an electrical potential associated with each of the pair of electrodes.

As used herein “connected” includes physical, whether direct or indirect, permanently affixed or adjustably mounted. Thus, unless specified, “connected” is intended to embrace any operationally functional connection.

As used herein “matrix” is intended to describe a substance, such as a polymer.

As used herein “composite” is intended to describe, a host material into which conductive material, such as carbon particles or titanium carbide, has been placed, for example, by mixing.

As used herein “sensor” refers to a composite material to which an IDT pattern has been applied configured such that pressure being applied thereto is detectable by a substantially linear or substantially exponential change in resistivity or conduction.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawings which are provided for illustration purposes as representative of specific exemplary embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

Given the following detailed description, it should become apparent to the person having ordinary skill in the art that the invention herein provides a novel intruder detection and location system and a method thereof for providing significantly augmented efficiencies while mitigating problems of the prior art.

### BRIEF DESCRIPTION OF THE DRAWINGS

The aspects of the present invention will become more readily apparent by describing in detail illustrative, non-limiting embodiments thereof with reference to the accompanying drawings, in which:

FIG. 1 is graph illustrating the resistivity response of a sensor in accordance with an exemplary embodiment of the present invention.

FIG. 2 is a diagram illustrating cross sectional view of an exemplary tile having IDT patterns applied to one surface.

FIGS. 3, 4 and 5 illustrate various exemplary IDT patterns.

FIG. 6 is an equivalent circuit of a sensor in accordance with the present invention in a non-conductive state.

FIG. 7 is an equivalent circuit of a sensor in accordance with the present invention in a conductive state.

FIG. 8 illustrates a number of interlocked tile panels in accordance with an embodiment of the present invention.

FIG. 9 is an exploded view illustrating a flooring unit comprising an underlay sheet and one or more floor tiles.

FIG. 10 is an expanded view of showing an exploded view of interlocking tiles.

FIG. 11 shows a microconnector in accordance with the invention.

FIG. 12 depicts a block diagram of a data acquisition system coupled to the tile panels of the present invention.

FIG. 13 illustrates a sheet of flooring tile with edge interlocking.

FIG. 14 is a block diagram illustrating a calibration device and procedure for a flooring system in accordance with the invention.

FIG. 15 shows an array of IDT electrodes arranged on a tile in accordance with an embodiment of the invention.

FIG. 16 illustrates a composite in which particles are compressed locally so as to cross the critical percolation threshold.

### DETAILED DESCRIPTION OF ILLUSTRATIVE, NON-LIMITING EMBODIMENTS

Exemplary, non-limiting, embodiments of the present invention are discussed in detail below. While specific configurations and dimensions are discussed to provide a clear understanding, it should be understood that the disclosed dimensions and configurations are provided for illustration purposes only. A person skilled in the relevant art will recognize that other dimensions and configurations may be used without departing from the spirit and scope of the invention.

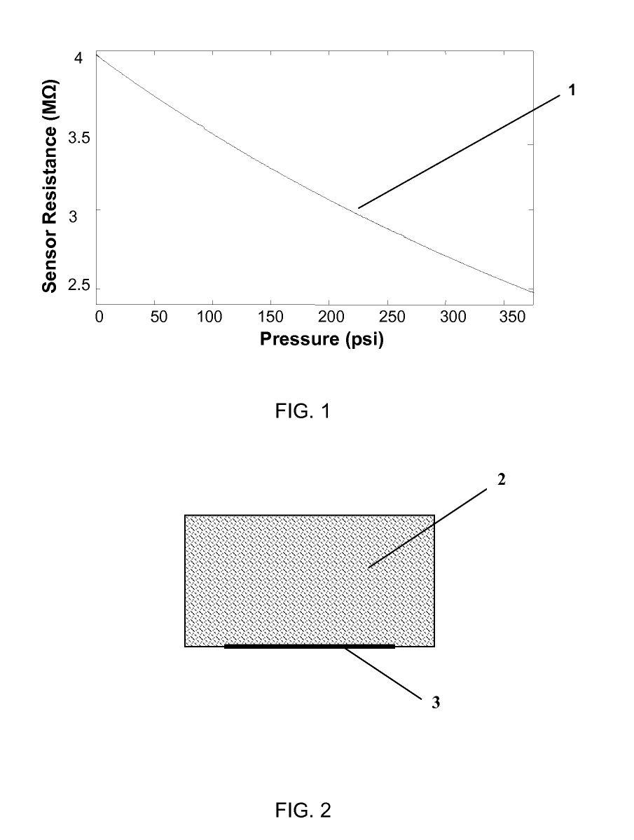

The present invention is directed to flooring systems comprised of novel metaplastic materials. Generally, metaplastic materials are composites comprising a polymer host, for example RTV, provided with a conductive filler such as Titanium Carbide. FIG. 1 illustrates plot line of resistance versus pressure for an exemplary metaplatic material developed for a 0 to 350 psi operational range. As illustrated, the exemplary metaplastic materials exhibits a substantially linear plot line or response 1. Metaplastics use the fact that unmodified polymers are good electrical insulators (10¹² to 10¹⁶ ohm-cm) and metals are good electrical conductors (10⁻⁶ to 10⁻¹ ohm-cm). By combining the two correctly, it is possible to enable dielectric materials whose bulk resistance varies with externally applied pressure.

Metaplastic materials should not be confused with the conduction elastomers commonly used for EMI/thermal shielding and gaskets. Such materials are specifically designed to have fixed electrical properties (e.g. bulk volume or surface resistivity) which are usually low values (0.01-70 ohm-cm) although these are on rare occasions modified to achieve lower levels of electrical conductivity for applications requiring electrostatic dissipation (10⁶ to 10¹⁰ ohm-cm). Conduction elastomers are designed to offer excellent resistance to compression, whereas, metaplastic materials are designed exactly opposite as to maximize compression induced changes in conductance. Indeed, many EMI or thermal conductive polymers need to utilize additional pressure sensitive adhesive or tape in their application precisely because they have no pressure response mechanism, contrary to metaplastic materials.

FIG. 2 illustrates an exemplary embodiment of a metaplastics based pressure sensor in accordance with the present invention and does not necessarily represent the exact configuration of a flooring system according to the invention. The embodiment consists of a metaplastic material 2 with one or more interdigitated electrode patterns 3 placed on the one side, e.g, the underside, of the material with trace electroding connecting each interdigitated electrode to a divider circuit where it becomes a passive resistor within the circuit whose value changes proportionally to pressure.

The metaplastic layer provides the underlying mechanism for sensing a stress, e.g., pressure, imposed at a particular location. As shown in FIG. 2, the exemplary metaplastic layer comprises a composite material 2 including a polymer host containing a distribution of conductive particles. The conductive particles are dispersed, for example using a doping process, within the polymer material. Further, according to one embodiment, composite material 2 is a polymer resin resistant to high temperatures and the conductive particles 32 are made of conductive material such as titanium carbide, carbon, titanium boride or a conductive polymer material. Other materials known to those of skill in the art, however, can be used provided they otherwise perform as described herein. The conductive particles can be of various sizes and shapes.

More particularly, conductive particles 12 are preferably, but not necessarily, randomly dispersed within the polymer host. However, if in strand or fiber form, it may be desirable to orient conductive particles 12 in a particular pattern. The volume fraction of conductive particles 12 may be selected according to the intended use of composite 10 as it affects the pressure/resistance relationship of the composite. In keeping with the invention, composite 10 is preferably fabricated so that it exhibits a substantially linear pressure/resistance relationship as illustrated in FIG. 1. Accordingly, composite 10 includes an appropriate volume fraction of conductive filler 12. Preferably composite 10 has a volume fraction of conductive filler 12 between 50% and 90%, more preferably between 60% and 80%, still more preferably between 65% and 75%.

Conductive filler 12 may have a particulate size ranging from about 1 μm to about 60 μm. In some embodiments, the particulate size may range from about 2 μm to about 10 μm. In still other embodiments, the particulate size may range from about 3 μm to about 5 μm. In addition to titanium carbide, other exemplary materials for conductive filler 12 include aluminum, gold, silver, nickel, copper, platinum, tungsten, tantalum, iron, molybdenum, hafnium, combinations and alloys thereof. Sr(Fe,Mo)O3, (La,Ca)MnO3, Ba(Pb,Bi)O3, vanadium oxide, antimony doped tin oxide, iron oxide, titanium diboride, titanium nitride, tungsten carbide, and zirconium diboride.

While not wishing to be bound by theory, it is believed that the composition, particle size, and volume fraction of conductive filler as well as the composition of thickness of the host all influence the pressure/resistance relationship of the composite.

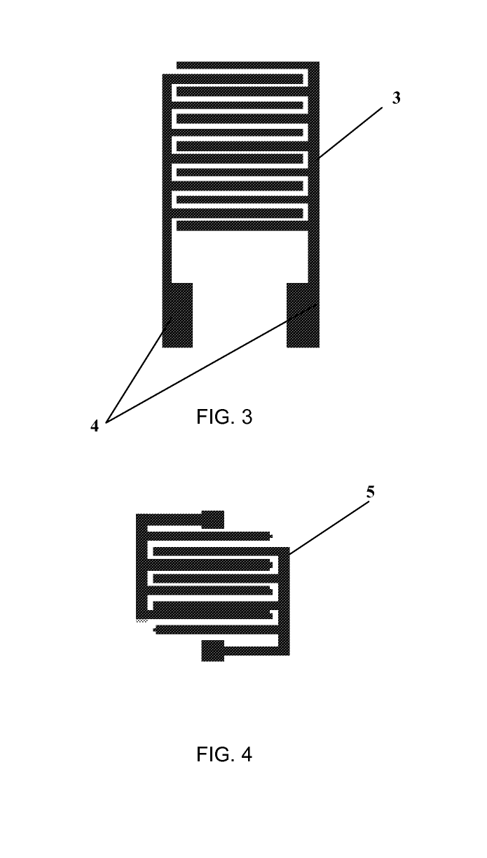

Electrode assembly 3 may comprise one or more IDT pattern electrodes such as those illustrated in FIGS. 3, 4, and 5, capable of detecting changing in pressure loading. FIG. 3 shows an exemplary embodiment of an IDT electrode pattern that may be added to the underside of the metaplastic composite material 2. The electrode pattern includes two closely spaced interdigitated electrodes 3 with conductive fingers 4 usually manufactured from platinum, gold, or other conductive material. The electrode layout has a small interelectrode capacitance which must be accounted for in the measurement circuit which depends upon the selection of IDT geometry and spacing of the fingers.

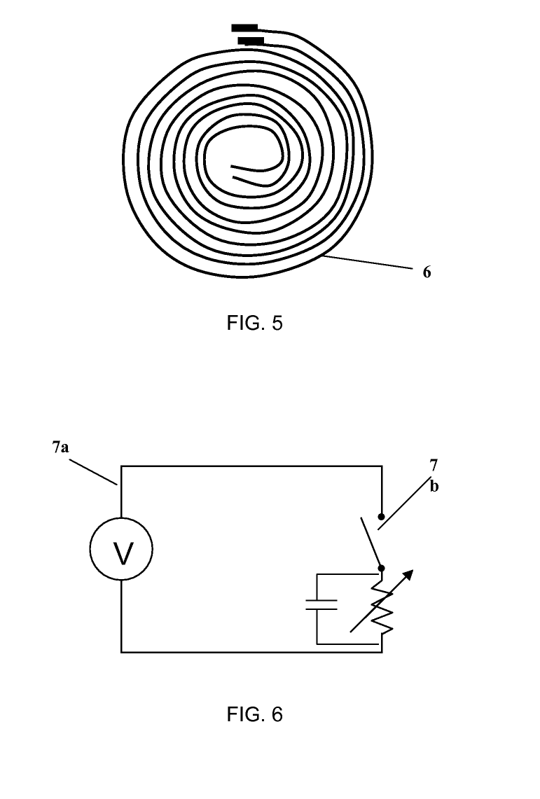

FIG. 4 illustrates another exemplary embodiment of an IDT electrode pattern. The electrode pattern includes two closely spaced interdigitated conductive fingers 5 providing an electrode width usually manufactured from platinum, gold, or other conductive material.

FIG. 5 depicts still another exemplary embodiment of an IDT electrode pattern. The electrode pattern includes two closely spaced interdigitated conductive spirals 6 in a rectangular, circular or other pattern. The electrode pattern is manufactured from conductive material such as platinum, gold, or conductive ink and can be formed using a variety of etch, direct write, photolithography or other standard circuit trace manufacture methods.

In keeping with the invention, the sensor of FIG. 2 is preferably distributed across a desired sensing area under a tile or carpet covering as part of a flooring system.

FIG. 2 illustrates metaplastic material 2 in a no load condition and, as such, in a non-conductive state. When the metaplastic material is in such a state, the conductive particles remain far enough from each other as to not permit electrical conduction between adjacent particles. The IDT electrodes 3 disposed on the underside of metaplastic material 2 experience no electron flow and are essentially inert. This condition is depicted electrically in FIG. 6 by open circuit 7b. In an unloaded state in which pressure is not applied to any surface of metaplastic material 2 electrical current does not flow in the locale of the fingers for the IDT electrodes because not enough conductive particles 32 contact one another in a sufficient manner to create a conductive path. The simplified model 7a of FIG. 6 includes small interelectrode capacitance. In the unloaded or no load condition, no energy is being drawn from the dc voltage source.

However, for example, as shown in FIG. 16, when pressure P is applied to a surface of composite 2, conductive particles 42 adjacent to the location of IDT electrodes 43 are compressed. That is, particles 42 are compressed and contact each other whereas particles 41 on either side of particles 42 are not compressed and do not contact each other. Accordingly, electrical current flows through the compressed, i.e., contacting, conductive particles 42 through flow path 44 and does not flow through particles 41.

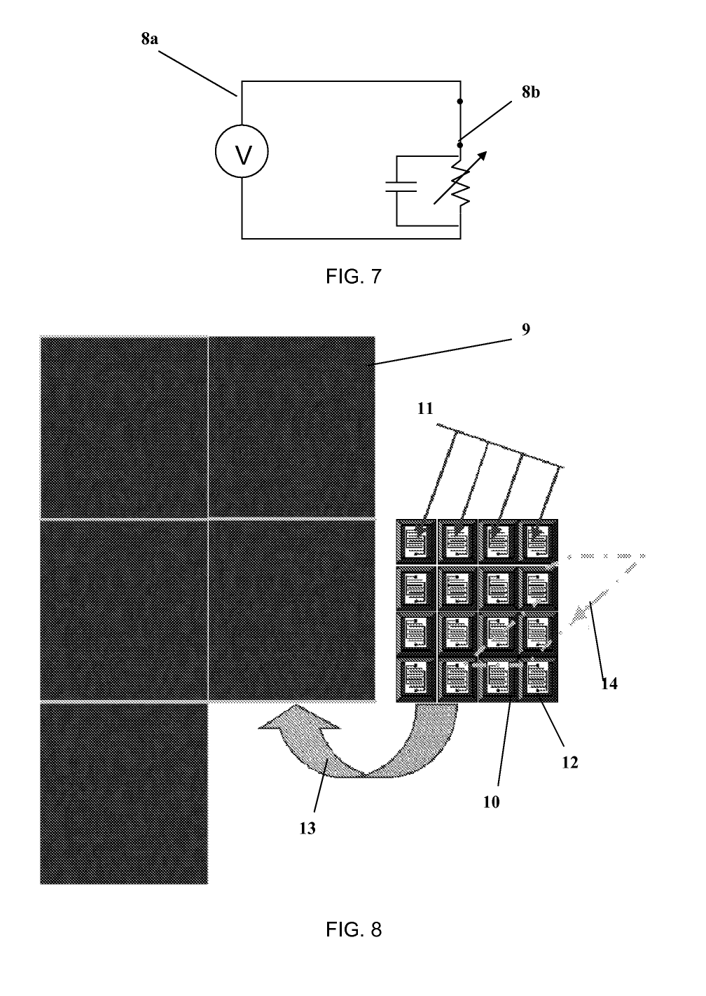

FIG. 7 illustrates an equivalent electrical circuit 8a for the conductive behavior of composite 2 under load or pressure. When pressure P is applied to one of the surfaces of composite 2 opposite to IDT electrode pattern 3, composite 2 crosses what is referred to as critical percolation where conductive particles are close enough to enable electron transport. The fingers of IDT electrodes 3 now create a conductive path 44 as illustrated in FIG. 16 when critical percolation occurs.

The IDT electrodes disposed on a surface of composite 2 experience electron flow and are essentially a variable resistor and the small interelectrode capacitance. Since the metaplastic material has no preferential direction, the IDT electrodes may be disposed on any face of, e.g., a cube shaped composite. Unlike any other pressure sensor, multiple such IDTs can be incorporated into multiple faces to measure loading conditions in multiple axes.

FIG. 8 depicts an embodiment of the invention defining a panel comprising a plurality of prefabricated tiles 9. Each prefabricated tile 9 includes a composite as illustrated and described in connection with FIG. 2. More particularly, each tile 9 includes a composite 2 and one or more IDT electrode pairs disposed on at least a single surface of composite 2, preferably the underside and a circuit network 7a to which the IDT electrodes function as a variable resistor.

In one embodiment, the tiles 9 includes an interconnect via set 10 and a plurality of IDT electrodes 11 arranged in a grid pattern and output signal trace lines 12. The individual tiles 9 may be interconnected in a selectively chosen pattern and placed on a designated floor area, for example. When a load is applied to any location adjacent an IDT electrode it will cause electron flow to occur at that IDT electrode. The electron flow causes a change in electrical resistance that, in the composite 2 of the present invention is substantially linear and that in a conventional percolation composite is sharply exponential. The application of load will cause electron flow along the path defined by the IDT terminations as originated by the small dc supply. The resistive IDT elements become part of an electrical divider network circuit (not shown) by way of ht etrace electrical interconnects 12 and the electrical vias 10.

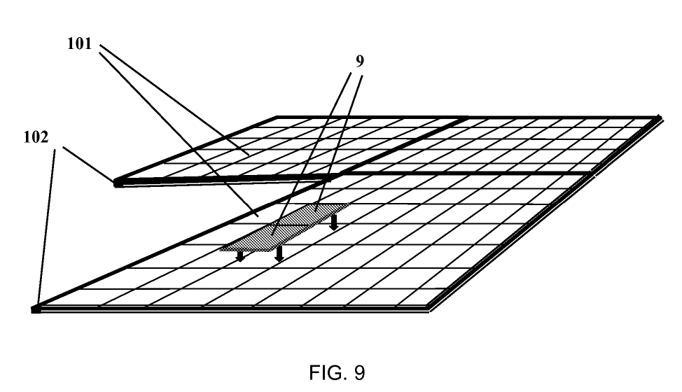

FIG. 9 shows an exemplary embodiment of a large area security flooring system using a pre-fabricated underlay sheet 101 supporting all the IDT patterned and trace interconnects terminating in a microconnector 102. The I/O is to pattern all the metallic interdigitated components and I/O read-out and (low) voltage level connections are pre-fabricated on a separate substrate such as large area polyimide or a direct written circuitry substrate designed to fit the desired flooring area.

Normally the off-area portion will be trimmed as it contains no circuit or patterning as to fit the floor footprint. Metaplastic tiles 9 can then be randomly installed on top of the pre-installed electrical underfloor. The individual tiles can be cut to size as to fit any irregular dimension or edge with no impact on the read-out measurement system.

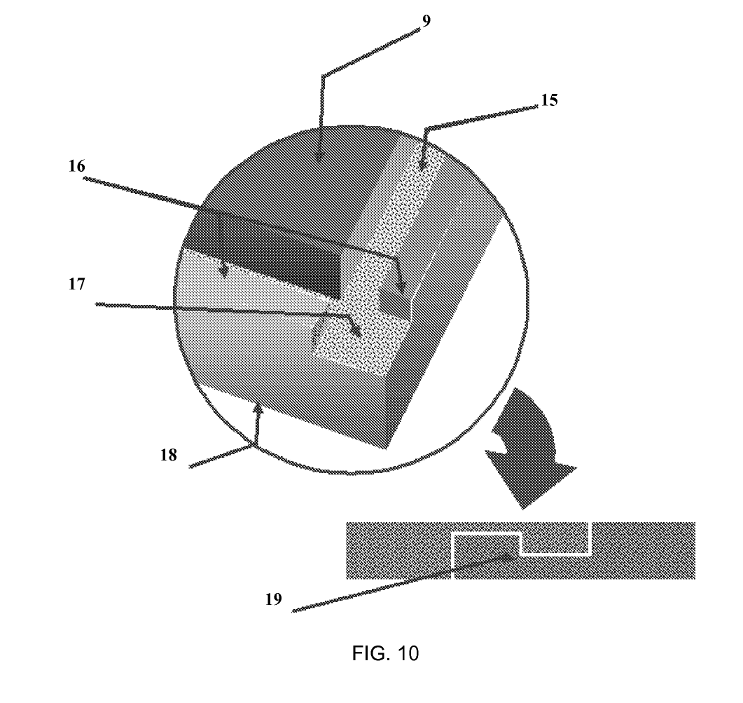

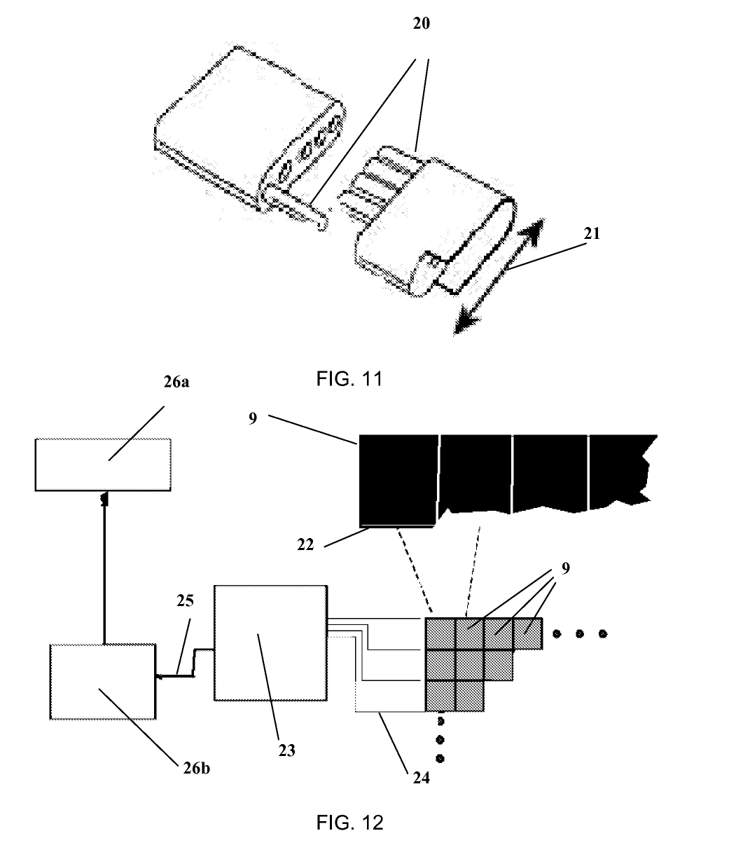

FIG. 10 is illustrates structures used to interconnect adjacent tiles 9. The output terminations would typically be interconnected to a Host Controller Device 22 via a floor connected USB or wireless channel connection 23 through the termination link 24. The floor connected USB or wireless channel connection 23 will typically connecy to the Host Controller Device 22 via a high speed link 25 optionally incorporating and ASIC or FPGA controller 26.

FIG. 11 is a pictorial representation of the exemplary embodiment of the ribbon cable or flex circuit microconnector that connects the vias 17 to the flooring exterior connection These via connects are terminated with a nanominiature strip (unshrouded) connector 21 that are flexible and less than ¼″ in width. The guide posts 20 ensure correct connection from the male of one tile to the female termination on the next sequential tile. The color coding 16 further ensures the correct orientation of the next tile and termination coupling.

FIG. 12 is a block diagram representation of a preferred embodiment of the data acquisition system. The approach to sequential data acquisition will employ embedded controllers (e.g. Xilinx programmable logic devices), UZBEE™ modules or LANTRONIX® Ethernet modules. Once the data is analyzed locally it will then be transmitted to a local command center or networked oversight system. The IDT signal outputs 24 are passed through an embedded voltage divider network which can optionally incorporate a microcontroller chip at each individual tile located at 17. One such microcontroller is a Texas Instruments (TI) MSP430 device. The resulting output 24 is USB row terminated or wireless channel connected to a USB Multichannel (Wireless) Hub or FPGA Processor 23. The hub than conveys this information as data packets over a high-speed interlink 25 to a host controller 26a. A single FPGA chip 26b could be integrated as to connect to all row buses in an installed intelligent floor system to the remote interface Host Controller Device (HCD). Also possible for data output control to be segmented into smaller FPGA devices where data display is assembled from smaller sub-matrices.

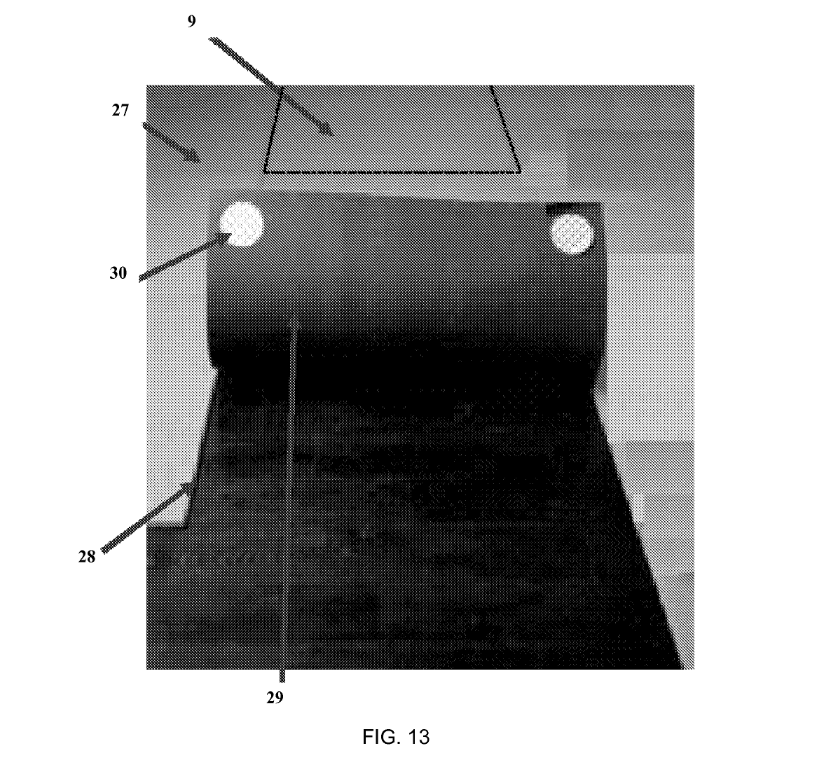

FIG. 13 is a pictorial diagram representation of tiled flooring 27 comprising metaplastic tiles 9 with edge interlocks 28. The metaplastic underlay 29 can optionally include low tack adhesive tabs 30 to enable easy repositioning.

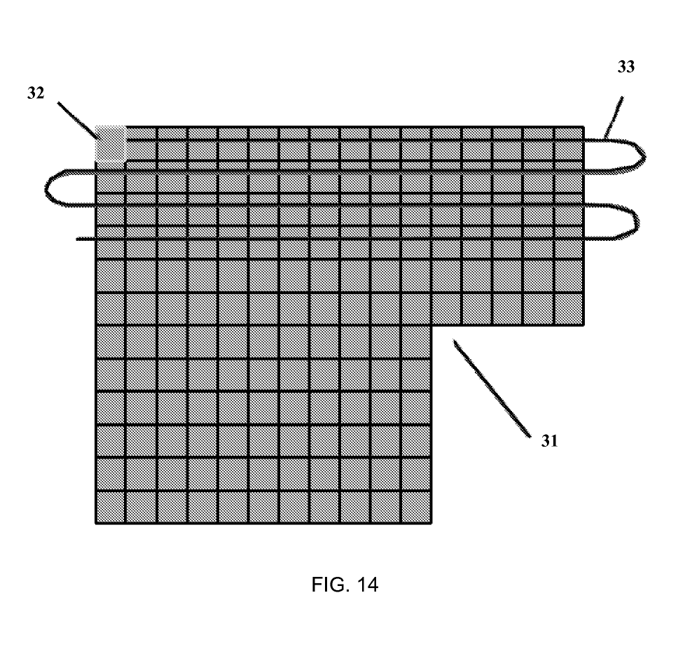

FIG. 14 is a block diagram representation of the position determination and pressure sensor calibration during an installation of the intelligent flooring system in accordance with the invention. Once the flooring is installed, the installer places a passive static or moving (roller) calibrator of precise weight that is approximately the same size as each individual tile on a tile 9. The installer follows the preset path 33 across the installed floor. When the calibrator is positioned on each individual tile 9, this tile and no other tile on the installed floor is electrically active and provides IDT signal output 24. Calibrating for an installer of known weight, this process can be done in a continuous, non-stop, fashion provided the installer is careful to always stand on a separate tile during position/calibration process (any outputs corresponding to installer loads are ignored). The tile with calibrator load transmits its unique (on-site set with software package or factory pre-set using microcontroller address) and as to inform the software exactly where this sensor is located in the room/building. The applied load can now be calibrated in software to the actual IDT(s) sensor output providing a series of calibrated and precisely positioned sensors covering the floor area. For tiles with multiple IDT patterning, a similar dynamic version of the calibrator can be used where the static or moving (roller) calibrator of precise weight employs a set of displacement actuators incorporated in its design to very the load in a prescribed fashion across each individual tile (and its set of IDT's). The software 22 records the IDT signal voltage outputs 24 for each such load variation and numerically stores both the individual sensors location and self-calibration using a series of differential measurement values.

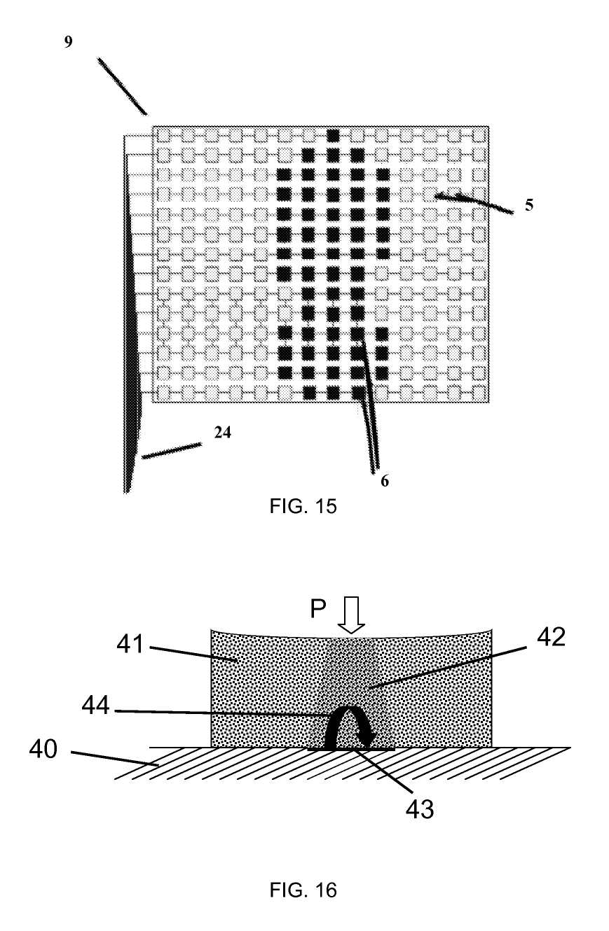

FIG. 15 is a diagram representation of a dense array of IDT devices installed onto a single tile 9. Specifically, the system shown in FIG. 15 includes a grid of IDT devices 5 comprising a plurality of pressure pixels interconnected in a row configuration. Although the pressure pixels in the present embodiment are illustrated as being rectangular in shape, and spaced apart from each other, these are not requirements and the pressure sensors in accordance with the invention can be of various shapes and sizes and they can also be in contact with adjacent sensors. That is, according to a further exemplary embodiment of the invention, discussed in detail below, the flooring material and/or associated sensor material can be made of a continuous planar material with the “pixilation” aspect of the flooring achieved, for example, by providing an array of discrete sensor interconnects.

As shown in FIG. 15, certain pressure pixels 6 have been “turned-on.” Specifically, the pixels 6 that are “turned-on” are represented by the darker shading of these pixels as compared to non turned-on pixels within pixels 5. Pixels 6 have been turned-on due to pressure having been applied to the flooring or sensor material in the area of the “turned-on” pixels. The applied pressure causes conduction of electrical current in the area corresponding to the pixel to which pressure was applied. For example, the turned-on pixels 6 are activated by a person walking on the grid 9. In accordance with this example, pixels 6 form a pattern that resembles the profile of the bottom of a shoe.

In accordance with one embodiment of the invention, the grid 5 of pressure pixels is large enough to cover an entire floor of an area to be monitored. Accordingly, when a person or any other object heavy enough to create a predetermined amount of pressure in the area of at least one pixels applies pressure to the pixels, the particular pixels to which pressure was applied are turned-on by having electrical current pass from one electrode through the pressure-sensing material and into another electrode, as explained in detail below. Accordingly, by monitoring and recording, for example, the time when each of the individual pressure pixels is turned on, it can be determined when the particular pixels were subjected to the pressure and precisely where within the grid the pressure was applied.

Although certain exemplary embodiments of the invention have been disclosed in the forgoing specification, it is understood by those skilled in the art that many other modifications and embodiments of the invention will come to mind to which the invention pertains, having benefit of the teaching presented in the foregoing description and associated drawings. It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

For example, in a real-time mode the current positions of weight bearing objects, including people, can be determined. This mode might be used, for example, in a hostage situation where the knowledge regarding precise location of individuals, hostage taker(s) as well as hostage(s), is critical.

Also, it is possible to arrange the electrode pattern in any geometry provided the logical topology remains consistent. Additionally, although a simple half bridge voltage divider was used to extract the measurement potential, for example with respect to the embodiment of FIG. 8, a person of ordinary skill in the art would understand that various other circuits can be used for measuring the output of each pixel 75.

Also, the matrix switches 71 used in FIG. 8 could be of many different types, for example: analog switches, BJT transistors, MOSFETS, JFETS, Thin-Film Transistors (TFTs), etc. A generic switch element is shown in FIG. 8 for clarity. All of the measurement components such as the fixed bridge resistor and switch could be located on the printed circuit for the substrate interconnect layer.

While various aspects of the present invention have been particularly shown and described with reference to the exemplary, non-limiting, embodiments above, it will be understood by those skilled in the art that various additional aspects and embodiments may be contemplated without departing from the spirit and scope of the present invention

It would be understood that a device or method incorporating any of the additional or alternative details mentioned above would fall within the scope of the present invention as determined based upon the claims below and any equivalents thereof.

Other aspects, objects and advantages of the present invention can be obtained from a study of the drawings, the disclosure and the appended claims.

What is claimed is:

1. A flooring system comprising:
a sheet of metaplastic composite material operable to conduct electrical current only when pressure is applied to at least one surface thereof; and
at least one interdigitated electrode in electrical contact with said sheet of composite material,
wherein an electrical voltage is applied to one side of the interdigitated electrode and electrical current flows from the one side of the interdigitated electrode through said sheet of pressure conduction composite and into the other side of the interdigitated electrode when load is applied to said sheet of composite in the vicinity of the interdigitated electrodes.

2. A flooring system as claimed in claim 1, further comprising:
a controller in electrical communication with said at least one interdigitated electrode and operable to sequentially detect the level of electrical current flowing through the interdigitated electrode;
a network circuit whose output voltage is proportional to the current flow across the interdigitated electrode and
a display device operable to display information representative of the level of voltage observed at the output of the network circuit.

3. A flooring system as claimed in claim 1 wherein said sheet of metaplastic composite comprises a plurality of electrically conductive particles and wherein an electrical resistance between the conducting interdigitated electrodes is dependent on the amount of load applied to said composite when said composite is subjected to an external pressure.

4. A flooring system operable to detect loads applied at any point on a flooring surface, said system comprising:
at least one sheet of metaplastic composite covering at least a portion of the flooring surface and operable to conduct electrical current when pressure is applied thereto; and
at least one pressure pixel each comprising a interdigitated electrode and a switch connected to one side of the interdigitated electrodes that is intimately attached to one face of the metaplastic composite;
a switch controlling portion connected to the switches and operable to controllably open and close the switches;
a pixel reading network connected to the switches and operable to measure an electrical potential associated with each of the interdigitated electrodes subjected to load and output a voltage proportional to the said load.

5. A flooring system as claimed in claim 4, wherein a plurality of pressure pixels are in electrical communication with said at least one sheet of pressure conduction composite and a variable electrical current corresponding to at least one of the pressure pixels is read by said pixel reading network, the value of the variable electrical voltage for each pixel read network being based on an a relative amount of pressure applied to the pressure conduction composite in the vicinity of the read pressure pixel.

6. A flooring system as claimed in 5, wherein the electrically conductive members comprise particles of one or more of carbon, titanium, boride and a conductive polymer.

7. A flooring system as claimed in claim 5, wherein the semi-rigid host material comprises a polymer.

8. A method of detecting pressure applied to a flooring surface, the method comprising:
providing a sheet of pressure conduction material capable of conducting a variable amount of electrical current based on an amount of pressure applied to at least one surface of the sheet;
providing a plurality of interdigitated electrode in electrical communication with said sheet;
placing the sheet and the interdigitated electrodes on at least a portion of said flooring surface;
applying an electrical potential to a one side of each interdigitated electrodes;
applying pressure to the sheet; and
detecting an flow of electrical current to the second side of the interdigitated electrodes, the amount of flow of electrical current across each one interdigitated electrodes being dependent on the amount of load applied to the sheet in the area of the respective electrode pair.

9. A method of detecting pressure applied to a flooring surface as claimed in claim 8, further comprising:
providing the electrode pairs in a grid pattern on the sheet, the grid pattern comprising at least one row of electrode pairs and at least one column of electrode pairs;
mapping the grid pattern of electrode pairs to a representation of the flooring surface; and
displaying representations of the values corresponding to the sequentially read electrical current from each output line and the mapped grid pattern on a display device;
wherein locations on the flooring surface where pressure is applied is displayed visually on the display device.

10. A method of detecting pressure applied to a flooring surface as claimed in claim 8, further comprising:
recording for a period of time the values corresponding to the electrical current detected in the second electrodes; and
displaying a composite representation of pressure applied to the flooring surface during at least a portion of the period of time.
